(19) United States
(12) Patent Application Publication
(10) Pub. No.: US 2006/0064495 A1
(43) Pub. Date: Mar. 23, 2006

(54) User profile selection

(76) Inventor: Edgar A. Tu, Castro Valley, CA (US)

Correspondence Address: FROMMER LAWRENCE & HAUG, 745 FIFTH AVENUE- 10TH FL., NEW YORK, NY, 10151, US

(21) Appl. No.: 10/917,088

(22) Filed: Aug. 11, 2004

(51) Int. Cl. G06F 15/16

(52) U.S. Cl. 709/228

(57) ABSTRACT

Methods and apparatus for selecting a user profile or preference. In one implementation, a controller for controlling a multimedia processing apparatus includes: a user/profile selector configured to enable a user to select an identifier that identifies a user or profile/preference to the multimedia processing apparatus so that one or more parameters of the multimedia processing apparatus and associated displays can be set according to the profile/preference associated with said identifier; and a transmitter configured to transmit the selected identifier to the multimedia processing apparatus.

### BACKGROUND

Graphical user interfaces provide end user interaction with computer programs, and are designed such that knowledge of specific commands and/or combinations of keystrokes is not required to efficiently and effectively use the computer program. A function can be carried out by the computer application, which owns the graphical user interface (GUI), by selecting or clicking with a mouse, a particular selection available in a GUI. Thus, in a typical GUI system, a group of visually distinct display objects are provided on the display screen, and are commonly referred to as “icons”. Each of the icons represents a function or object, and may be configured as a pointer or symbol connecting the function or object to a file or contents.

The graphical user interface can be incorporated into consumer electronic products including audio-visual systems such as televisions and stereos. The GUI provides a capability to configure the audio-visual system with a particular configuration according to the profile/preference of a user/viewer/listener by allowing the entry of the profile/preference. Typically, the interface with the audio-visual system is made using a remote controller.

As described above, availability of the user profile selection in a user interface system provides a capability to customize the system for a particular user while providing flexibility to change the system settings to accommodate preferences of multiple users. For example, the logon program for the Windows™ operating system includes a capability to provide an initial logon menu screen using a graphical user interface (GUI), which allows the user to logon to a specific account among several accounts. In this setup, each account can be configured according to the profile/preference of the account user.

However, above-described conventional techniques of providing a customized configuration of the system according to the profile/preference, entered through a GUI, present various difficulties of having to navigate through different levels of menu screens and enter multiple commands of button clicks and passwords.

### SUMMARY

The present invention provides methods and apparatus for selecting a user profile or preference. In one implementation, a controller for controlling a multimedia processing apparatus includes: a user/profile selector configured to enable a user to select an identifier that identifies a user or profile/preference to the multimedia processing apparatus so that one or more parameters of the multimedia processing apparatus and associated displays can be set according to the profile/preference associated with said identifier; and a transmitter configured to transmit the selected identifier to the multimedia processing apparatus.

In another implementation, a multimedia processing system includes: at least one display; a multimedia processing apparatus configured to receive and process a plurality of contents spread over a plurality of media; and a user/profile selector configured to enable a user to select an identifier that identifies a user or profile/preference to the multimedia processing apparatus so that one or more parameters of the multimedia processing apparatus and associated displays can be set according to the profile/preference associated with said identifier.

In another implementation, a method for controlling a multimedia processing apparatus includes: enabling a user to select an identifier that identifies a user or profile/preference to the multimedia processing apparatus so that one or more parameters of the multimedia processing apparatus and associated displays can be set according to the profile/preference associated with said identifier; and transmitting the selected identifier to the multimedia processing apparatus.

In another implementation, a computer program, stored in a tangible storage medium, for use in controlling a multimedia processing apparatus, includes executable instructions that cause a computer to: enable a user to select an identifier that identifies a user or profile/preference to the multimedia processing apparatus so that one or more parameters of the multimedia processing apparatus and associated displays can be set according to the profile/preference associated with said identifier; and transmit the selected identifier to the multimedia processing apparatus.

### BRIEF DESCRIPTION OF THE DRAWINGS

FIG. 1 shows one implementation of a multimedia processing system including a composite apparatus capable of processing a plurality of contents.

FIG. 2 is a functional block diagram showing one implementation of the multimedia processing apparatus.

FIG. 3 shows another implementation of a multimedia processing system.

FIG. 4 illustrates a particular implementation of a controller, which includes a plurality of entry keys, a plurality of selection keys, a joystick, a plurality of functions keys, and a user/profile selector.

FIG. 5 is a functional block diagram showing another implementation of the multimedia processing apparatus and the controller.

FIGS. 6A and 6B provide a method for enabling user/profile/preference selection in a multimedia processing system.

FIG. 7 illustrates one example of an alternative implementation to the implementation shown in FIG. 4 in which the user/profile selector is configured with push buttons labeled ‘1’ to ‘5’ to identify five different users.

### DETAILED DESCRIPTION

This disclosure describes systems and methods that enable user profile/preference selection. Various implementations of the user profile/preference selection in a multimedia processing system are described.

In particular, the user/profile selector allows the user to select a profile or preference by entering either the identity of the user or the profile/preference identifier through a controller. Thus, the entered user/profile/preference identifier identifies a user or profile/preference to the multimedia processing apparatus so that one or more parameters of the multimedia processing apparatus and associated displays can be set according to the profile/preference associated with the identifier, without requiring the user to enter the user/profile/preference identifier through a cumbersome process of a graphical user interface menu.

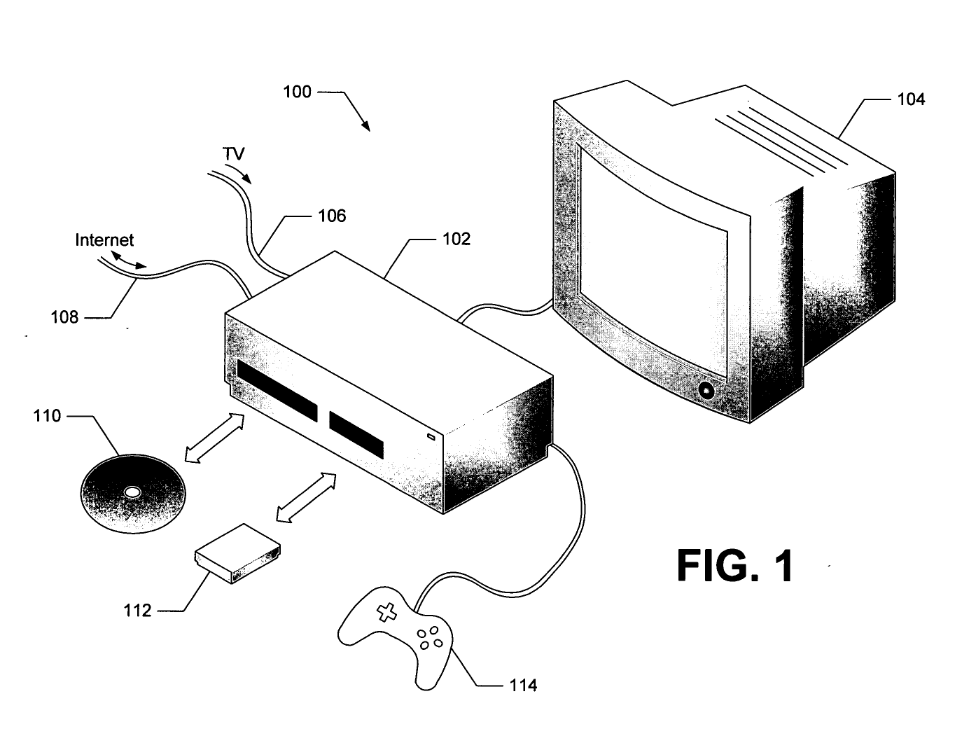

FIG. 1 shows one implementation of a multimedia processing system 100, which includes a composite apparatus capable of processing a plurality of contents, such as still images, moving images, music, broadcasts, and games, spread over a plurality of media. The processing of a plurality of contents includes presentation, recording, and other related tasks performed by the multimedia processing system 100. The multimedia processing system 100 includes a multimedia processing apparatus 102, a display 104 (e.g., a monitor or television), and a controller 114.

The multimedia processing apparatus 102 receives multimedia contents from various media sources, such as broadcast media, the Internet media, an optical disk 110, and a memory card 112. Contents from the broadcast media can be received through line 106, while contents from the Internet media can be received through line 108. The contents from the broadcast media and the Internet media can be recorded and stored by the multimedia processing apparatus 102. The received contents can also be used by various functions (e.g., a game) of the multimedia processing apparatus 102.

The received multimedia contents are displayed on the display 104. The controller 114 allows the user to input various instructions related to multimedia processing, and to control functions of the multimedia processing apparatus 102.

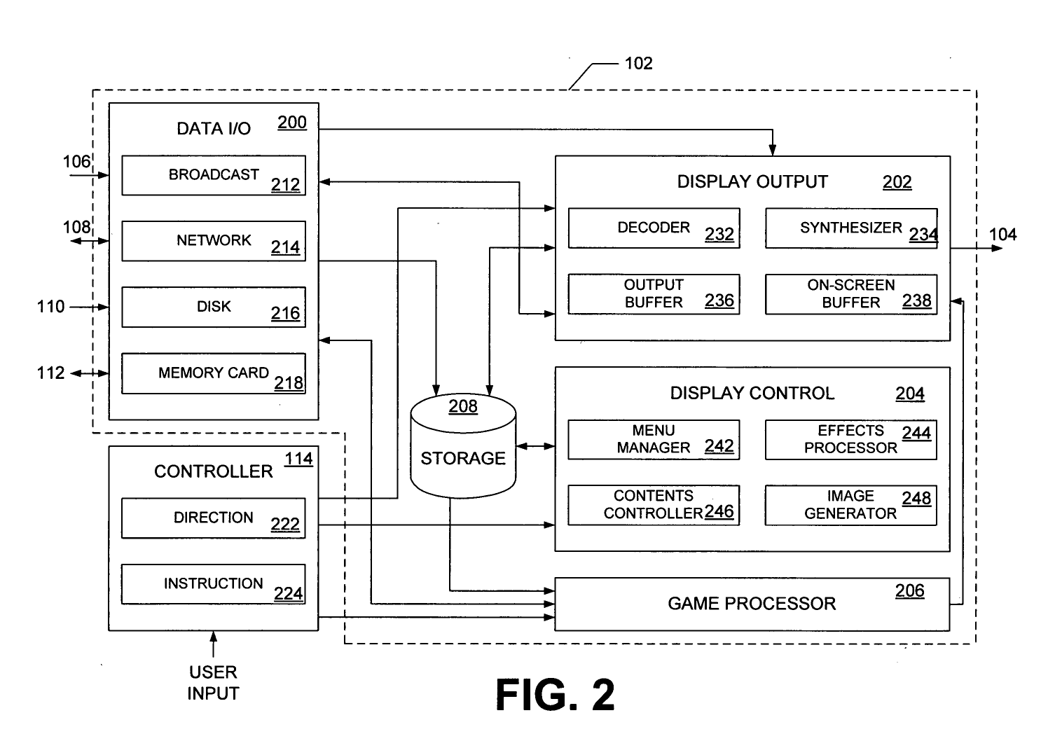

FIG. 2 is a functional block diagram showing one implementation of the multimedia processing apparatus 102 and the controller 114. In the illustrated implementation, the multimedia processing apparatus 102 includes a data input/output (I/O) unit 200, a display output unit 202, a display control unit 204, a storage unit 208, and a game processor 206. The multimedia processing apparatus 102 further includes programs and instructions for performing various functions, such as a data input function, a data retaining function, an image processing function, a rendering function, and other related functions.

In the illustrated implementation, the controller 114 includes a direction-determining unit 222 for determining one or a combination of four directions (i.e., an upward direction, a downward direction, a left direction, and a right direction) from the user input; and an instruction-determining unit 224 for determining an instruction from the user input. The instruction may include a command to present a multimedia content, to terminate the presentation, to invoke a menu screen, and to issue other related commands and/or instructions. Output of the controller 114 is directed to the display output unit 202, the display control unit 204, and the game processor 206. In another implementation, the controller 114 can be implemented as a remote controller remotely providing directions and instructions.

In the illustrated implementations of FIGS. 1 and 2, the direction-determining unit 222 and the instruction-determining unit 224 are configured with a combination of buttons, circuits, and programs to actuate, sense, and determine the direction and the instruction. The buttons can include cross-shaped keys or joysticks. The button associated with an instruction for invoking a menu screen can be set in a toggle manner so that the menu screen can be toggled between a display mode and a non-display mode each time the button is pressed.

In one implementation, the direction-determining unit 222 may determine the diagonal movements of the button as a binary command in which the movement is ascertained to be in one of two directions. Thus, a diagonal movement between the up direction and the right direction can be ascertained to be in either the up or the right direction. In another implementation, the direction-determining unit 222 may determine the diagonal movements of the button as an analog command in which the movement is ascertained to be in a particular direction up to the accuracy of the measurement. Thus, a diagonal movement between the up direction and the right direction can be ascertained to be in a northwesterly direction.

The data I/O unit 200 includes a broadcast input unit 212 for inputting broadcast contents via the television line 106; a network communication unit 214 for inputting and outputting data such as web contents via the Internet line 108; a disk reading unit 216 for inputting data stored on a disk 110; and a memory card reading unit 218 for inputting and outputting data to/from a memory card 112. Output of the data I/O unit 200 is directed to the display output unit 202, the display control unit 204, the game processor 206, and the storage unit 208.

The display output unit 202 includes a decoder 232, a synthesizer 234, an output buffer 236, and an on-screen buffer 238. The decoder 232 decodes input data received from the data I/O unit 200 or the storage unit 208. Thus, the input data may include broadcast contents, movie, and music. The synthesizer 234 processes the decoded input data based on user direction/instruction received from the controller 114. The output of the synthesizer 234 is stored in the output buffer 236. The on-screen buffer 238 stores image data of the menu screen generated by the display control unit 204. The output of the display output unit 202 is transmitted to the display 104.

The display control unit 204 includes a menu manager 242, an effects processor 244, a contents controller 246, and an image generator 248. The menu manager 242 manages media items and multimedia contents received from the storage unit 208 and the data I/O unit 200, and shown on the menu screen. The effects processor 244 processes operation of icons and icon arrays on the menu screen. The effects processor 244 also manages various actions and effects to be displayed on the menu screen. The contents controller 246 controls processing of media items and multimedia contents, and handling of data from the data I/O unit, the storage unit 208, and the game processor 206. The image generator 248 operates to generate a menu screen including a medium icon array and a contents icon array.

The game processor 206 executes a game program using data read from the data I/O unit 200 or from the storage unit 208. The game processor 206 executes the game program based on user instructions received from the controller 114. The display data of the executed game program is transmitted to the display output unit 202.

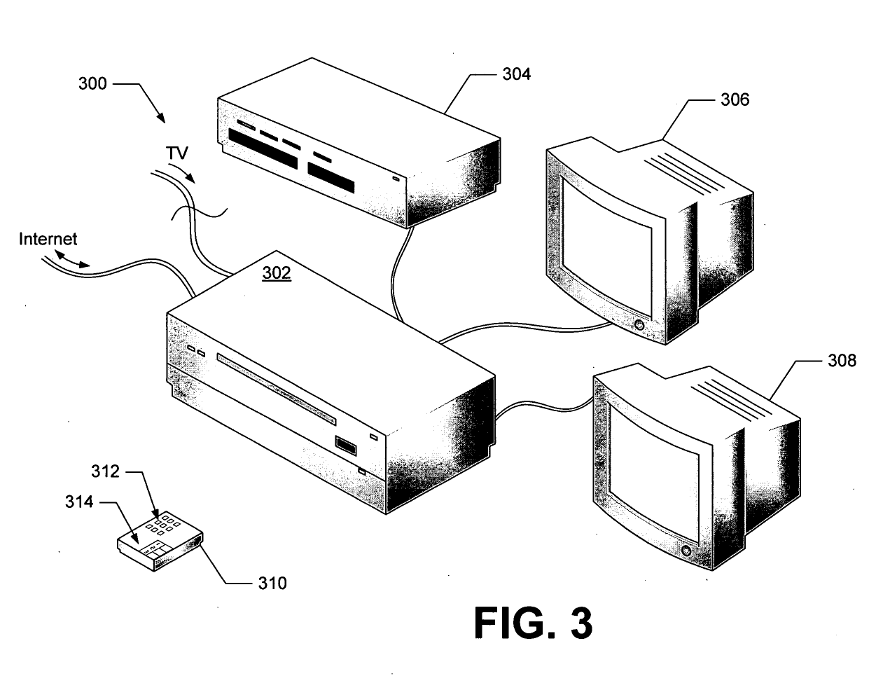

FIG. 3 shows another implementation of a multimedia processing system 300, which includes a multimedia processing apparatus 302, and a plurality of multimedia devices 304, 306, 308 coupled to the multimedia processing apparatus 302. The multimedia devices 304, 306, 308 may be configured as video player/recorder, audio player/recorder, or other related devices operating to receive and transmit multimedia contents, and can include display devices 306, 308 such as a television or a monitor. In a particular implementation, the multimedia processing apparatus 302 can be configured as a home entertainment center such as a PlayStation PSX™.

The multimedia processing system 300 further includes a controller 310, similar to the controller 114 of FIG. 1, configured to control and manage the processing of multimedia contents by the multimedia processing apparatus 302.

In the illustrated implementation of FIG. 3, the controller 310 is implemented as a remote controller remotely providing control and management instructions. However, the controller can be implemented as a “wired” controller coupled to the multimedia processing apparatus 302. The controller 310 includes a plurality of keys and buttons 312 configured to allow search, selection, and entry of commands and instructions. The controller 310 also includes a user/profile selector 314 to allow selection of a user profile.

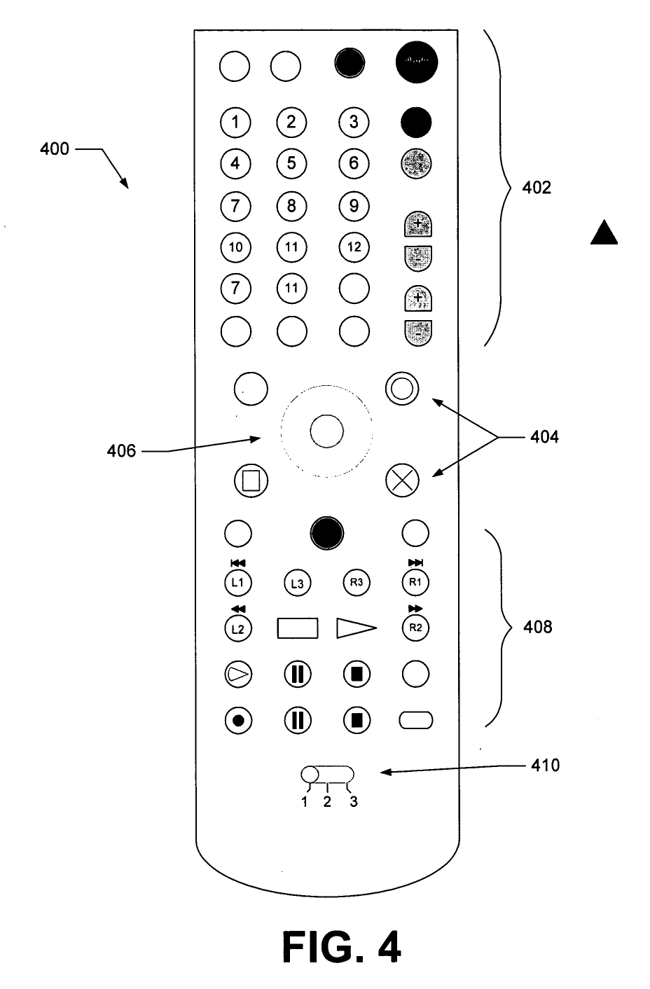

FIG. 4 illustrates a particular implementation of a controller 400, which includes a plurality of entry keys 402, a plurality of selection keys 404, a joystick 406, a plurality of functions keys 408, and a user/profile selector 410.

In the particular implementation, the user/profile selector 410 is configured with a switch that enables the user to enter the user/profile/preference identifier. The controller 400 transmits the entered identifier to the multimedia processing apparatus 302, which can be configured to receive the identifier and retrieve profile/preference data. Thus, one or more parameters of the multimedia processing apparatus and associated displays can be set according to the profile/preference data. In another implementation, the controller 400 transmits the identifier along with control commands sent to the multimedia processing system. In this case, the multimedia processing system interprets a received command according to the profile indicated by the identifier received with the command.

Although the particular implementation shows the user/profile selector 410 with a capability to enter and identify only three different users or profiles, the user/profile selector 410 can be configured to enable the identification of any number of different users and/or profiles.

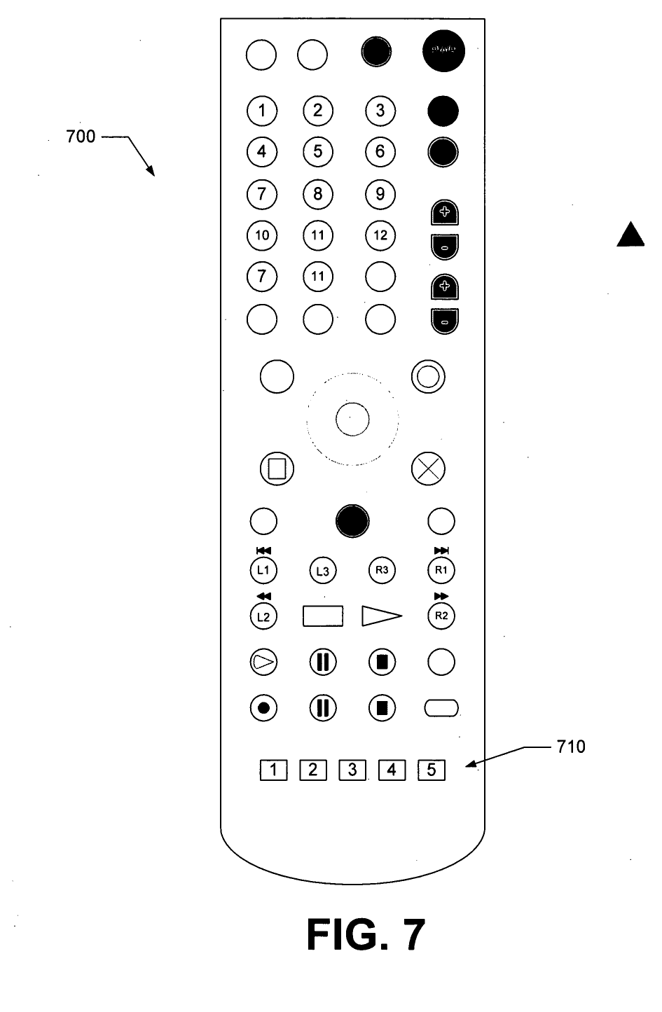

In an alternative implementation, the user/profile selector 410 can be configured with other related elements, such as push buttons, to enable the user to enter the user/profile/preference identifier. FIG. 7 illustrates one example of the alternative implementation in which the user/profile selector 710 is configured with push buttons labeled ‘1’ to ‘5’ to identify five different users. In other implementations, a different selector or additional selectors can be provided, such as a voice or speech recognition interface, a biometric (e.g., fingerprint) interface, or a wireless interface to receive an identifier from another wireless device (e.g., a magnetic card).

In a further implementation, the user/profile selector 410 can be configured with one or more buttons/switches to indicate whether user or profile is being identified. The plurality of entry keys 402 can then be used to select a particular user/profile identifier. In one example, the user/profile selector 410 can be switched to ‘user’ while pressing ‘5’ to select a user #5 profile. In another example, the user/profile selector 410 can be switched to ‘profile’ while pressing ‘5’ to select profile #5.

In a further implementation, the user/profile selector 410 can be configured to provide the multimedia processing apparatus 302 with user profile/preference data rather than just the identity of the user. Thus, in this implementation, the controller 400 includes a memory that can store the user profile/preference data for the plurality of users. In one implementation, the controller stores security or authentication information for an identifier or profile, so that a password or other verification is required before a selected profile is available (e.g., where access to some media is restricted to certain profiles, a password requirement for a parent's profile provides a “child lock” to prevent a child from using the parent's profile to access the restricted media).

In a further implementation, the controller 400 includes the user/profile selector 410 configured to select an identifier that identifies a user or profile/preference to the multimedia processing apparatus 302 so that one or more parameters of the multimedia processing apparatus and associated displays can be set according to the profile/preference associated with the identifier. The controller 400 also includes a memory to store the identifier and pre-selected or pre-collected profile/preference data; and a processor to associate the identifier with the pre-selected or pre-collected profile/preference data.

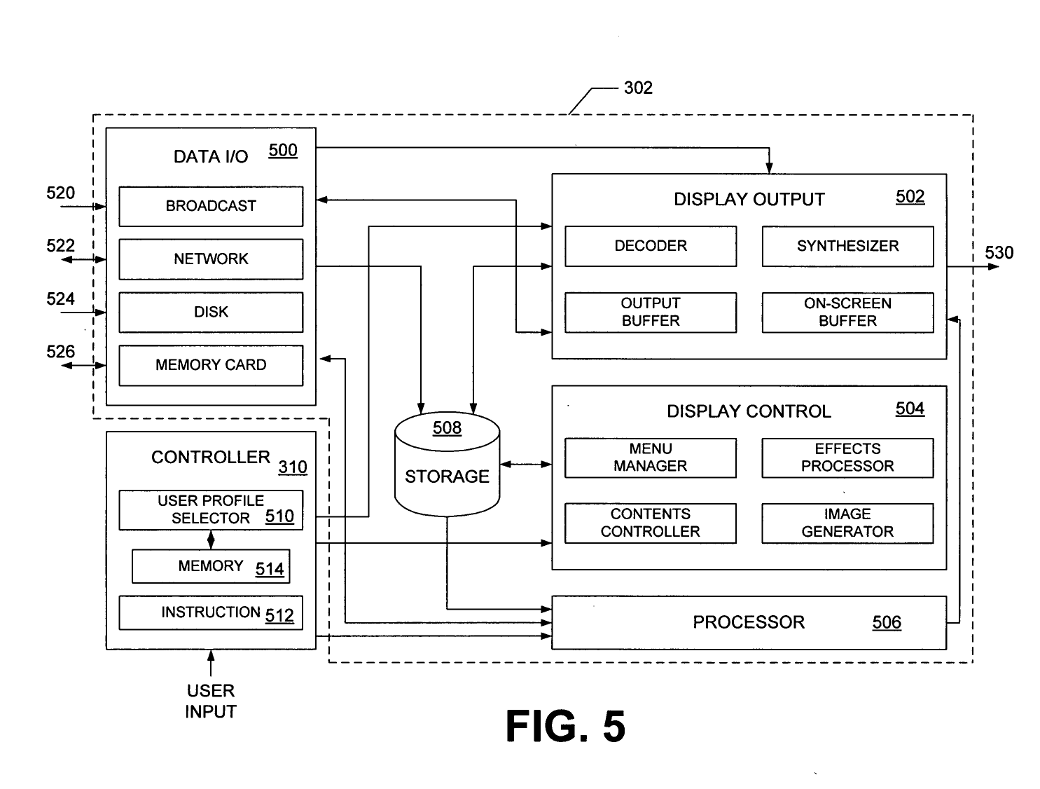

FIG. 5 is a functional block diagram showing another implementation of the multimedia processing apparatus 302. In the illustrated implementation, the multimedia processing apparatus 302 includes the controller 310, a data input/output (I/O) unit 500, a display output unit 502, a display control unit 504, a processor 506, and a storage unit 508.

The multimedia processing apparatus 302 further includes programs and instructions for performing various functions, such as a data input function, a data retaining function, an image processing function, a rendering function, and other related functions.

The data input/output (I/O) unit 500, the display output unit 502, the display control unit 504, and a storage unit 508 are configured substantially similarly to the data input/output (I/O) unit 200, the display output unit 202, the display control unit 204, and a storage unit 208, respectively. However, in the illustrated implementation of FIG. 5, the configurations of these units 500, 502, 504, 508 are modified to incorporate and integrate modifications to the controller 310 and the processor 506, as described below.

Inputs 520, 522, 524, 526 to the multimedia processing apparatus 302 are substantially similar to inputs 106, 108, 110, 112, shown in FIG. 2. Further, output 530 from the multimedia processing apparatus 302 is substantially similar to output 104, shown in FIG. 2.

In the illustrated implementation of FIG. 5, the controller 310 includes a user/profile selector 510, a memory 514, and an instruction-determining unit 512. The user/profile selector 510 provides the multimedia processing apparatus with a selected user/profile/preference identifier so that the configuration of the multimedia processing apparatus and associated displays can be customized.

In some implementations, the user/profile selector 510 also enables the user to select, set, and store the profile/preference on the controller 310. The selection, setting, and storage of the profile/preference can be programmed on the controller 310 by associating each stored profile/preference with a user/profile/preference identifier. In this implementation, the profile/preference is stored in the memory 514.

The instruction-determining unit 512 determines instructions for controlling the multimedia processing apparatus from inputs entered by the user. The instruction may include a command to present a multimedia content, to terminate the presentation, to invoke a menu screen, and to issue other related commands and/or instructions.

The processor 506 in the multimedia processing apparatus 302 receives the selected user/profile/preference identifier and determines the profile/preference associated with the user/profile/preference identifier. In some implementations, the determination may include retrieving profile/preference data from the storage 508. The processor 506 then processes the profile/preference data by transmitting and managing operations of the display output unit 502 and the display control unit 504 so that a display menu screen is configured according to the retrieved profile/preference. In other implementations, the determination may include receiving the profile/preference data stored in the memory 514 of the controller 310 and associating the profile/preference data with the user/profile/preference identifier.

In one implementation, the operation of the processor 506 may also include controlling the operation of the multimedia processing apparatus 302 according to the user/profile/preference identifier. In another implementation, the operation of the processor 506 may further include collection (including “pre-collection”) and storage of profile/preference data.

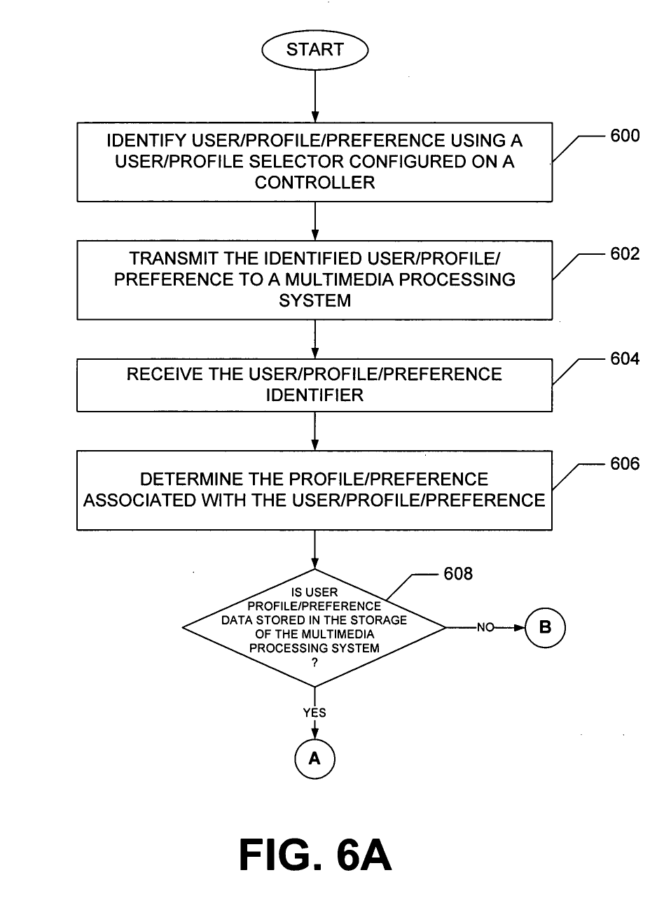

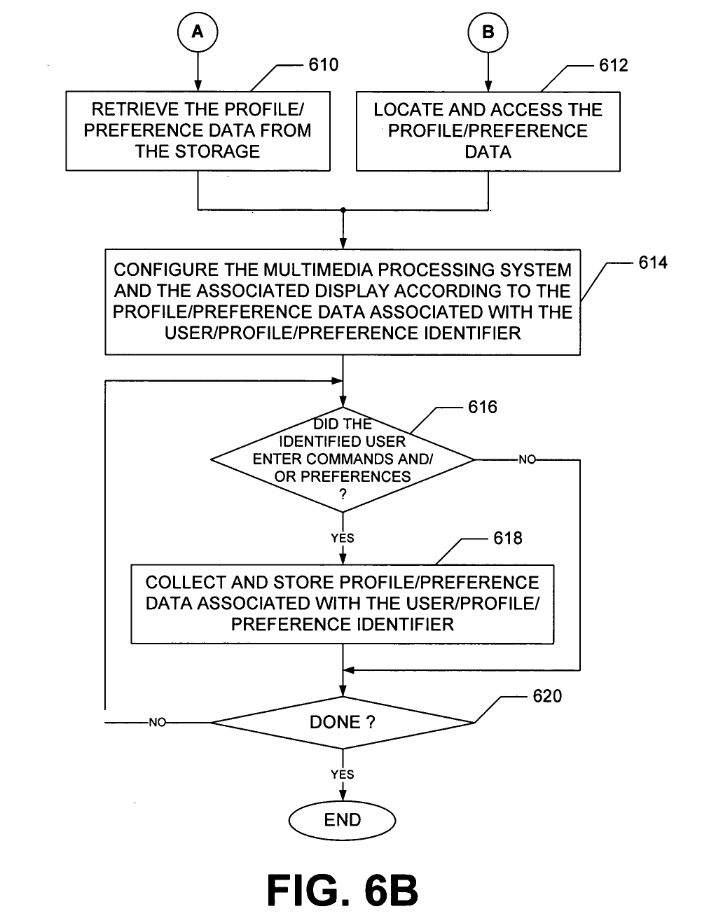

FIG. 6 is a method for enabling user/profile/preference selection in a multimedia processing system. The method is divided into two flowcharts, FIG. 6A and FIG. 6B.

In the illustrated implementation, user/profile/preference is identified, at 600, using a user/profile selector configured on a controller. At 602, the identified user/profile/preference is transmitted to the multimedia processing system, which receives the identifier at 604.

The user profile/preference associated with the identifier is determined, at 606, 608, 610, 612. If it is determined, at 608, that the profile/preference data is stored in the storage of the multimedia processing system, the profile/preference data associated with the identifier is retrieved from the storage of the multimedia processing system, at 610. Otherwise, the profile/preference data is located and accessed, at 612.

In one implementation described above, the profile/preference data is stored in the storage of the controller. In this implementation, the profile/preference data is transmitted from the controller and is received at the multimedia processing system, at 612. The multimedia processing system and the associated display(s) are configured according to the profile/preference data associated with the user/profile/preference identifier, at 614.

In a further implementation, profile/preference data associated with a selected user/profile/preference identifier is collected and stored, at 618, when it is determined, at 616, that commands and/or preferences are entered. The user normally enters the commands and/or preferences through the controller. However, the commands and/or preferences can be entered into the multimedia processing system through other means. The collection and storage of the profile/preference data associated with the user/profile/preference identifier will continue, at 620, when there more commands and/or preferences to be entered and collected.

In a further implementation, a method for controlling a multimedia processing apparatus includes enabling a user to select an identifier that identifies a user or profile/preference to the multimedia processing apparatus so that one or more parameters of the multimedia processing apparatus and associated displays can be set according to the profile/preference associated with the identifier. The selected identifier is then transmitted to the multimedia processing apparatus.

The method also includes storing the identifier, and associating the identifier with pre-selected or pre-collected profile/preference data. Operations of the multimedia processing apparatus and associated displays can be managed according to the retrieved profile/preference data. The method further includes collecting and storing profile/preference data associated with the identifier when the user enters commands and/or preferences.

Various implementations of the invention are realized in electronic hardware, computer software, or combinations of these technologies. Most implementations include one or more computer programs executed by a programmable computer. For example, in one implementation, the system for enabling user profile/preference selection includes one or more computers executing software implementing the user profile/preference selection discussed above. In general, each computer includes one or more processors, one or more data-storage components (e.g., volatile or non-volatile memory modules and persistent optical and magnetic storage devices, such as hard and floppy disk drives, CD-ROM drives, and magnetic tape drives), one or more input devices (e.g., mice and keyboards), and one or more output devices (e.g., display consoles and printers).

The computer programs include executable code that is usually stored in a persistent storage medium and then copied into memory at run-time. The processor executes the code by retrieving program instructions from memory in a prescribed order. When executing the program code, the computer receives data from the input and/or storage devices, performs operations on the data, and then delivers the resulting data to the output and/or storage devices.

Although various illustrative implementations of the present invention have been described, one of ordinary skill in the art will see that additional implementations are also possible and within the scope of the present invention.

Accordingly, the present invention is not limited to only those implementations described above.

What is claimed is:

1. A controller for controlling a multimedia processing apparatus, comprising:
a user/profile selector configured to enable a user to select an identifier that identifies a user or profile/preference to the multimedia processing apparatus so that one or more parameters of the multimedia processing apparatus and associated displays can be set according to the profile/preference associated with said identifier; and
a transmitter configured to transmit the selected identifier to the multimedia processing apparatus.

2. The controller of claim 1, wherein the user/profile selector includes a selection switch configured to enable easy entry of said identifier.

3. The controller of claim 1, wherein the user/profile selector includes push buttons configured to enable easy entry of said identifier.

4. The controller of claim 1, further comprising
a storage element configured to provide retention of said identifier within the controller.

5. The controller of claim 1, further comprising
an instruction-determining unit configured to determine instructions for controlling the multimedia processing apparatus from inputs entered by the user.

6. A multimedia processing system, comprising:
at least one display;
a multimedia processing apparatus configured to receive and process a plurality of contents spread over a plurality of media; and
a user/profile selector configured to enable a user to select an identifier that identifies a user or profile/preference to the multimedia processing apparatus so that one or more parameters of the multimedia processing apparatus and associated displays can be set according to the profile/preference associated with said identifier.

7. The multimedia processing system of claim 6, wherein said plurality of contents includes at least one of still images, moving images, music, broadcasts, and games.

8. The multimedia processing system of claim 6, wherein said plurality of media includes at least one of broadcast media, Internet media, optical disk media, and memory card media.

9. The multimedia processing system of claim 6, wherein the multimedia processing apparatus includes a storage element to store profile/preference data associated said identifier.

10. The multimedia processing system of claim 9, wherein the multimedia processing apparatus includes
a processor to receive said identifier and determine the profile/preference data associated with said identifier, said processor operating to retrieve the profile/preference from the storage element.

11. A method for controlling a multimedia processing apparatus, comprising:
enabling a user to select an identifier that identifies a user or profile/preference to the multimedia processing apparatus so that one or more parameters of the multimedia processing apparatus and associated displays can be set according to the profile/preference associated with said identifier; and
transmitting the selected identifier to the multimedia processing apparatus.

12. The method of claim 11, further comprising:
storing said identifier; and
associating said identifier with pre-selected or pre-collected profile/preference data.

13. The method of claim 12, further comprising
retrieving the pre-selected or pre-collected profile/preference data.

14. The method of claim 13, further comprising
managing operations of the multimedia processing apparatus and associated displays according to the retrieved profile/preference data.

15. The method of claim 11, further comprising
collecting and storing profile/preference data associated with said identifier when the user enters commands and/or preferences.

16. A controller for controlling a multimedia processing apparatus, comprising:
means for enabling a user to select an identifier that identifies a user or profile/preference to the multimedia processing apparatus so that one or more parameters of the multimedia processing apparatus and associated displays can be set according to the profile/preference associated with said identifier; and
means for transmitting the selected identifier to the multimedia processing apparatus.

17. The controller of claim 16, further comprising:
means for storing said identifier; and
means for associating said identifier with pre-selected or pre-collected profile/preference data.

18. The controller of claim 17, further comprising
means for retrieving the pre-selected or pre-collected profile/preference data.

19. The controller of claim 18, further comprising
means for managing operations of the multimedia processing apparatus and associated displays according to the retrieved profile/preference data.

20. The controller of claim 16, further comprising
means for collecting and storing profile/preference data associated with said identifier when the user enters commands and/or preferences.

21. A computer program, stored in a tangible storage medium, for controlling a multimedia processing apparatus, the program comprising executable instructions that cause a computer to:
enable a user to select an identifier that identifies a user or profile/preference to the multimedia processing apparatus so that one or more parameters of the multimedia processing apparatus and associated displays can be set according to the profile/preference associated with said identifier; and
transmit the selected identifier to the multimedia processing apparatus.

22. The computer program of claim 21, further comprising executable instructions that cause a computer to:
store said identifier; and
associate said identifier with pre-selected or pre-collected profile/preference data.

23. The computer program of claim 22, further comprising executable instructions that cause a computer to
retrieve the pre-selected or pre-collected profile/preference data.

24. The computer program of claim 23, further comprising executable instructions that cause a computer to
manage operations of the multimedia processing apparatus and associated displays according to the retrieved profile/preference data.

25. The computer program of claim 21, further comprising executable instructions that cause a computer to
collect and store profile/preference data associated with said identifier when the user enters commands and/or preferences.

26. A controller for controlling a multimedia processing apparatus, comprising:
a user/profile selector configured to select an identifier that identifies a user or profile/preference to the multimedia processing apparatus so that one or more parameters of the multimedia processing apparatus and associated displays can be set according to the profile/preference associated with said identifier;
a memory to store said identifier and pre-selected or pre-collected profile/preference data; and
a processor to associate said identifier with the pre-selected or pre-collected profile/preference data.

27. The controller of claim 26, wherein
the processor collects and stores the profile/preference associated with said identifier when the user enters commands and/or preferences.
